(19) United States
(12) Patent Application Publication
(10) Pub. No.: US 2011/0255968 A1
(43) Pub. Date: Oct. 20, 2011

(54) ADJUSTER DEVICE FOR AN AIRCRAFT, COMBINATION OF AN ADJUSTER DEVICE AND AN ADJUSTER DEVICE FAULT RECOGNITION FUNCTION, FAULT-TOLERANT ADJUSTER SYSTEM AND METHOD FOR RECONFIGURING THE ADJUSTER SYSTEM

(75) Inventor: Martin Recksiek, Hamburg (DE)

(73) Assignee: AIRBUS OPERATIONS GMBH, Hamburg (DE)

(21) Appl. No.: 13/125,381

(22) PCT Filed: Oct. 22, 2009
(86) PCT No.: PCT/EP09/07571

§ 371 Date: Apr. 21, 2011

Related U.S. Application Data
(60) Provisional application No. 61/114,487, filed on Nov. 14, 2008.

(30) Foreign Application Priority Data
Oct. 22, 2008 (DE) 10 2008 052 754.8

(51) Int. Cl. B64C 9/00

(52) U.S. Cl. 416/23

(57) ABSTRACT

An adjustment device to be coupled to an adjustment flap of an aircraft, with an actuator, adjustment kinematics, and a gearing, wherein the adjustment device can be coupled to a controller/monitor for purposes of its actuation. The adjustment device includes a first load sensor, on the input side of the actuator for determining the load arising on the input side due to actuation of the adjustment flap, and a second load sensor, on the output side of the actuator for determining the load arising on the output side due to actuation. The first load sensor and second load sensor are functionally linked with a fault-recognition function for receiving sensor values ascertained by the load sensors, to assign a fault state to the adjustment device. A combination of an adjustment device and a fault recognition function, a fault-tolerant adjustment system, and a method for reconfiguring the adjustment system are also provided.

The invention relates to an adjustment device for an aircraft, a combination of an adjustment device and adjustment device fault recognition system, and a method for reconfiguring the adjustment system. The adjustment flap is generally an adjustable, aerodynamic flap of an aircraft, and can in particular be a high-lift flap. In particular, the adjustment system can be a high-lift system of an aircraft.

Known from general prior art are high-lift systems with load limiters for avoiding excess loads, in particular when conflicts between forces arise.

U.S. Pat. No. 7,195,209 describes a load sensor for the drive mechanisms of high-lift systems, with which the load at the output of an actuator is measured.

The object of the invention is to provide an adjustment device for coupling to an adjustment flap of an aircraft, a combination of an adjustment device and an adjustment device fault recognition function, a fault-tolerant adjustment system, and a method for reconfiguring of an adjustment system, which localize faults arising in the high-lift system with a minimal equipment outlay, and can be used to implement an efficient system degradation to compensate for the respectively arising fault.

This object is achieved with the features in the independent claims. The subclaims referring back to the latter describe additional embodiments.

In particular, the solution according to the invention can be used to predict fault states in an adjustment device.

The invention provides an adjustment device or operating device for coupling to an adjustment flap of an aircraft, which exhibits:
an actuator and servo kinematics for kinematically coupling the actuator to the adjustment flap,
a first load sensor, which is arranged on the input side of the actuator for detecting the load arising on the input side of the actuator as the result of actuating the adjustment flap,
a second load sensor, which is arranged at the output side of the actuator for detecting the load arising on the output side of the actuator as the result of actuating the adjustment flap.

In this case, the first load sensor and second load sensor are functionally coupled to an adjustment device fault recognition function to transmit the sensor values acquired by the load sensors, so as to monitor the functional state of the adjustment device. The latter is designed in such a way that it can assign a fault state to the servo devices allocated to a flap based on the signals transmitted by the load sensors.

When two or more adjustment devices are arranged on a flap, it can be provided that only one of the adjustment devices according to the invention is designed with two load sensors. The at least one additional adjustment device can be designed to have only one of the two load sensors, or none of the load sensors.

In particular, the adjustment device according to the invention can be used as one of several adjustment devices of a high-lift system for the adjustment of leading edge flaps or trailing edge flaps. The adjustment kinematics can here in particular be designed as “track kinematics” or “dropped hinge kinematics”. In “track kinematics”, the servo device is designed as a carriage guided on a rail (“track”) via an actuator. The servo flap is coupled to the carriage via a driving rod, wherein a first hinge preferably couples the driving rod to the carriage, and a second hinge couples the driving rod to the servo flap. In so-called “dropped hinge kinematics”, the actuator is designed as a rotating actuator.

Another aspect of the invention provides for a combination of such an adjustment device and adjustment device fault recognition function. The adjustment device has an actuator and activating kinematics for kinematically coupling the actuator to the adjustment flap. As an option, the adjustment device can also exhibit a gearing, with which the power generated by the drive mechanism is transmitted to the actuator. The adjustment device can be coupled to a controller/monitor to actuate the latter. The adjustment device exhibits:
a first load sensor, which is arranged on the input side of the actuator for detecting the load arising on the input side of the actuator as the result of actuating the adjustment flap,
a second load sensor, which is arranged at the output side of the actuator for detecting the load arising on the output side of the actuator as the result of actuating the adjustment flap.

The first load sensor and second load sensor are here functionally connected with the adjustment device fault recognition function to receive the sensor values acquired by the load sensors, so as to assign a fault state to the adjustment device if predetermined criteria have been satisfied as a function of these sensor values. The adjustment device fault recognition function is here designed in such a way as to be able to monitor the functional state of the adjustment device.

The adjustment device fault recognition function can be configured in such a way that it compares the respective sensor values of the first and second load sensor with at least one limiting value, and determines the fault state of the adjustment device based on whether the signal values of the first and second load sensor exceed or dip below this limiting value.

In particular, the adjustment device fault recognition function can be configured in such a way that, when the first load sensor and second load sensor each detect values below a no-load limit, the adjustment device fault recognition function assigns a ‘nonfunctional’ state (Failure Case A), and hence a failure state, to the respective adjustment device.

It can here be provided that a value has dropped below the no-load limit when the first load sensor transmits a sensor signal to the adjustment device fault recognition function, indicating a load under ⅕ the operating load defined as the maximum at the location of the first load sensor, and the second load sensor indicates a load defined as under ⅕ of the operating load defined as the maximum at the location of the second load sensor, or actually arises during normal operation. A maximum operating load can be prescribed based on the layout of the wing or aircraft. Therefore, a fault state can be assigned to an adjustment device when the first load sensor transmits a sensor signal to the adjustment device fault recognition function measuring less than a no-load limit, the value of which is under ⅕ of the value corresponding to the maximum prescribed or actual operating load at the location of the first load sensor, and the second load sensor transmits a sensor signal to the adjustment device fault recognition function measuring less than a no-load limit, the value of which is under ⅕ of the value corresponding to the maximum prescribed or actual operating load at the location of the first load sensor. In particular, it can here also be provided that the ‘nonfunctional’ state is assigned given compliance with the condition that the aircraft is on the ground at the same time the value dips below the no-load limit.

In particular, the adjustment device fault recognition function can be configured in such a way that, in another case also referred to herein as case B, the adjustment device fault recognition function assigns a fault state to the output side of an adjustment device in the event of a jam, if the second load sensor generates and transmits to the adjustment device fault recognition function a signal value corresponding to a load L₂, which exceeds a prescribed limiting value corresponding to an operating load at the location of the second load sensor, and if the load L₁ measured by the first load sensor lies in the operating range of the input side of the respective adjustment kinematics corresponding to that of the load L₂ measured by the second load sensor.

It can here be provided in particular that the prescribed limiting value for an operating load at the location of the second load sensor is a prescribed or determined maximum load Lₘₐₓ for the output side.

In particular, the adjustment device fault recognition function can be configured in such a way that, in another case referred to as Case C below, the adjustment device fault recognition function assigns a fault state to the respective adjustment device given a jamming of the actuator or a transmission section lying between the first load sensor and second load sensor in relation to the mechanical transfer chain if the signal value for a load L₁ of the input side generated by the first load sensor exceeds a value for the operating range of the input side of the respective adjustment kinematics that the adjustment device fault recognition function nominally ascertains from the load L₂ measured by the second load sensor.

It can here be provided in particular that the load L₁ measured by the first load sensor more than doubles the load L₂ measured by the second load sensor, taking onto account the gear ratio of the actuator.

In particular, the adjustment device fault recognition function can be configured in such a way that, in a case (D), the adjustment device fault recognition function assigns a fault state to an actuator or transmission section lying between the first load sensor and second load sensor based on a condition of limited performance capacity if the adjustment device fault recognition function determines that the load ascertained with the first load sensor exceeds a prescribed limiting value, and the load ascertained with the second load sensor dips below a prescribed limiting value, or if the ratio

$$\frac{{L}_{1}}{{L}_{2}}$$

of the load L₁ ascertained with the first load sensor exceeds a prescribed limiting value in relation to the load L₂ ascertained with the second load sensor.

In the exemplary embodiments, a position sensor can generally be arranged on the adjustment kinematics to acquire the position of the adjustment flap.

Another aspect of the invention also provides a fault-tolerant adjustment system with at least one flap that can be adjusted on one of the respective wings of an aircraft, and with a controller/monitor having adjustment devices that are actuated by the controller/monitor, and of which at least one is allocated to each flap.

At least one or two of the adjustment devices can be arranged on a respective flap of a wing, spaced apart from each other in the wingspan direction of the flap, and coupled to a drive connection. It can here be provided that the one or more adjustment device(s) respectively coupled to an adjustment flap each be coupled to a separate drive mechanism, or that the adjustment devices of all flaps of a adjustment system or high-lift system be coupled to a drive mechanism, which in particular can be centrally arranged, e.g., in the fuselage of the aircraft, wherein the drive mechanism is mechanically coupled with the adjustment devices of each wing by way of a power train, e.g., a rotating shaft, for purposes of its actuation.

At least one adjustment device of a flap is here designed based on one of the exemplary embodiments according to the invention, and exhibits: a first load sensor on the input side of the actuator for acquiring a load and a second load sensor on the output side of the actuator for acquiring a load. According to the invention, the fault-tolerant adjustment system further exhibits a controller/monitor functionally linked with the load sensors, which is designed to be able to assign a fault state to the servo devices allocated to a flap based on the signals transmitted by the load sensors.

In particular, the fault-tolerant adjustment system can exhibit drive mechanisms, one of which is respectively allocated to the at least one adjustment device of a respective flap, which are functionally linked with a controller/monitor that actuates the latter, and which each exhibit: two drive motors, two braking devices, wherein the drive motors have allocated to them at least one braking device for stopping the output of the respective drive motor.

The adjustment devices can be coupled to a drive mechanism respectively allocated to the flap by means of a respective drive connection. In addition, at least two adjustment devices can be connected to each flap, and spaced apart in the wingspan direction of the flap.

A respective drive mechanism can be allocated to each flap.

One exemplary embodiment of the adjustment systemfault-tolerant adjustment system according to the invention provides that the drive mechanism coupled with at least one adjustment device exhibits at least one braking device, and that the controller/monitor exhibits:
a servo function for actuating the drive mechanism of the flap,
a monitoring function that generates a command signal to at least one braking device and optionally to a differential lock as well for actuating the latter, and sends it to them when the monitoring function of the adjustment device has assigned a fault state.

The controller/monitor of the fault-tolerant adjustment system can also exhibit:
a servo function for actuating the drive mechanism of the flap,
a monitoring function that generates a command signal to at least one braking device (B-a, B-b) for actuating it, and sends it to the latter when the monitoring function of the adjustment device has ascertained varying adjustment states that exceed a predetermined level based on a comparison of position sensors on two different adjustment devices of a flap.

In the exemplary embodiments of the fault-tolerant adjustment system according to the invention, the latter can exhibit in particular a high-lift system reconfiguration function, which is functionally linked with an adjustment device fault recognition function, and generates or influences commands for actuating the adjustment devices as a function of fault states transmitted to it by the adjustment device fault recognition function.

The actuator or speed-transforming gear can consist of a rotating actuator or a linear drive. The used two drive motors can be electric drive motors. Two drive motors can also be used, wherein one is an electric drive motor, and the other a hydraulic drive motor. The at least one drive motor can also be a hydraulic drive motor.

The invention further provides a method for reconfiguring a high-lift system with adjustable adjustment flaps, with the following steps:
determining signal values from a first load sensor and a second load sensor to ascertain loads arising on an adjustment device with an actuator, wherein the first load sensor is arranged on the input side, and the second load sensor is arranged on the output side,
subject to a determination of whether the conditions relating to the signal values ascertained by the first load sensor and second load sensor have been met, assigning a fault state to a component of the respective adjustment device.

Exemplary embodiments of the invention will be described below based on the attached drawings, which show:

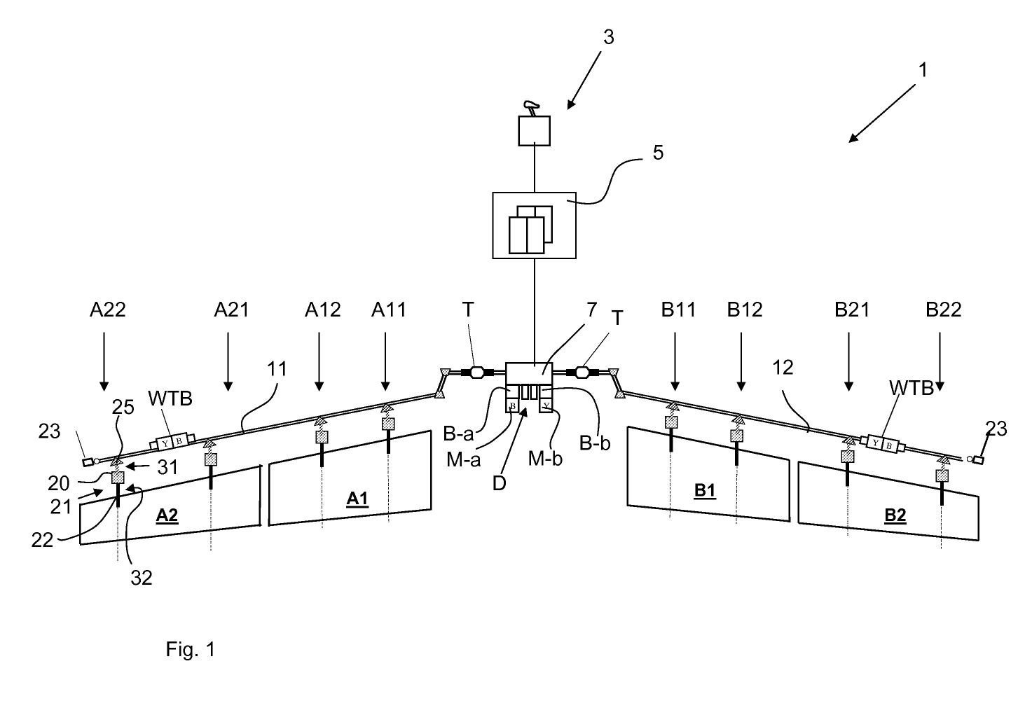

FIG. 1 a diagrammatic view of an embodiment of the high-lift system adjustment flaps, of which two are provided for each wing, with adjustment devices for actuating the adjustment flaps, wherein the adjustment devices each [exhibit] at least one actuator and at least one first load sensor situated on the input side and at least one second load sensor situated on the output side of the at least one actuator, and wherein the adjustment devices are driven by a central drive motor and a rotating shaft coupled with the latter;

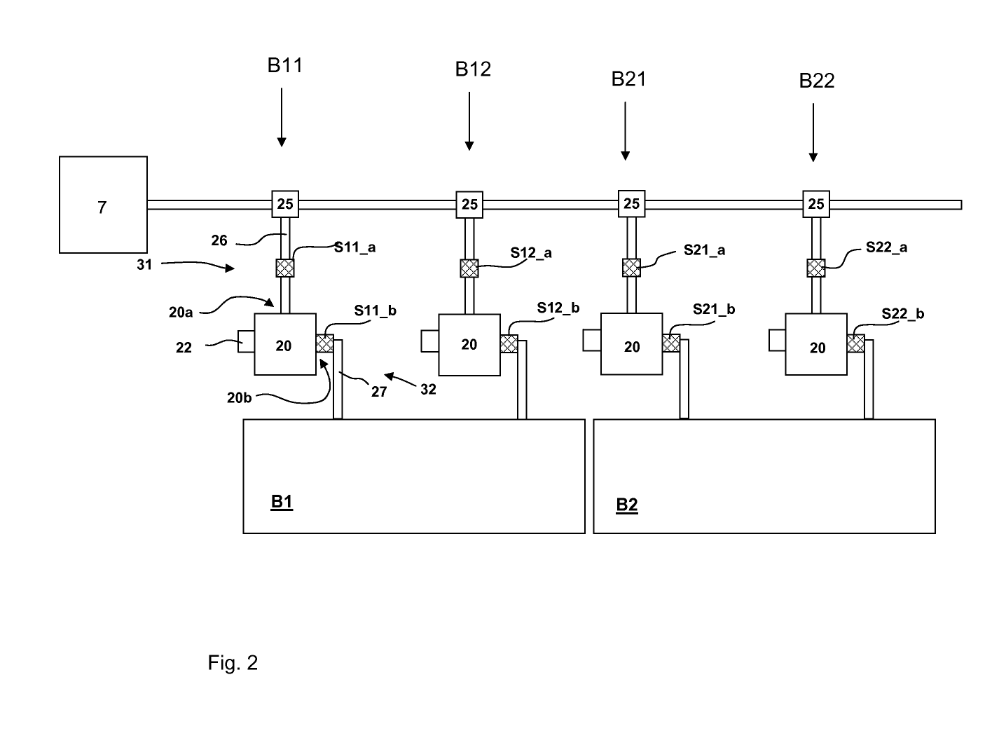

FIG. 2 is a magnified view of the section of the high-lift system according to FIG. 1 provided for the right wing viewed in the longitudinal axis of the plane;

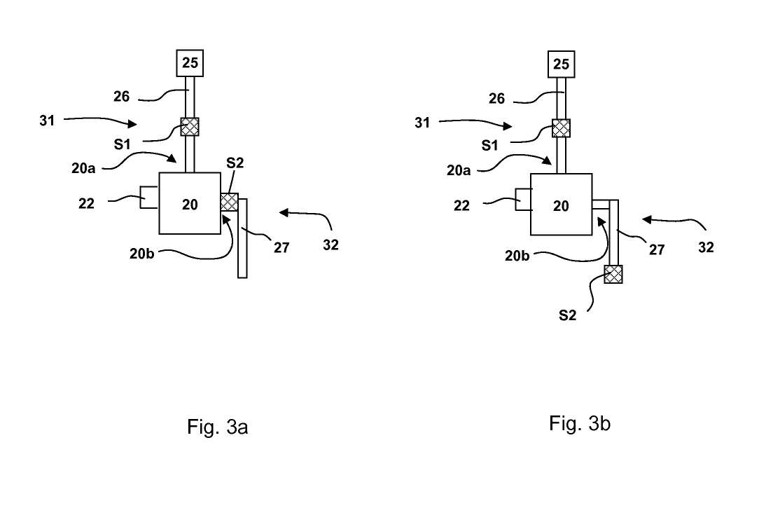

FIG. 3a is an embodiment of an adjustment device according to the invention, in which the load sensor arranged on the output side thereof is designed as a torque sensor;

FIG. 3b is an embodiment of an adjustment device according to the invention, in which the load sensor arranged on the output side thereof is designed as a force sensor;

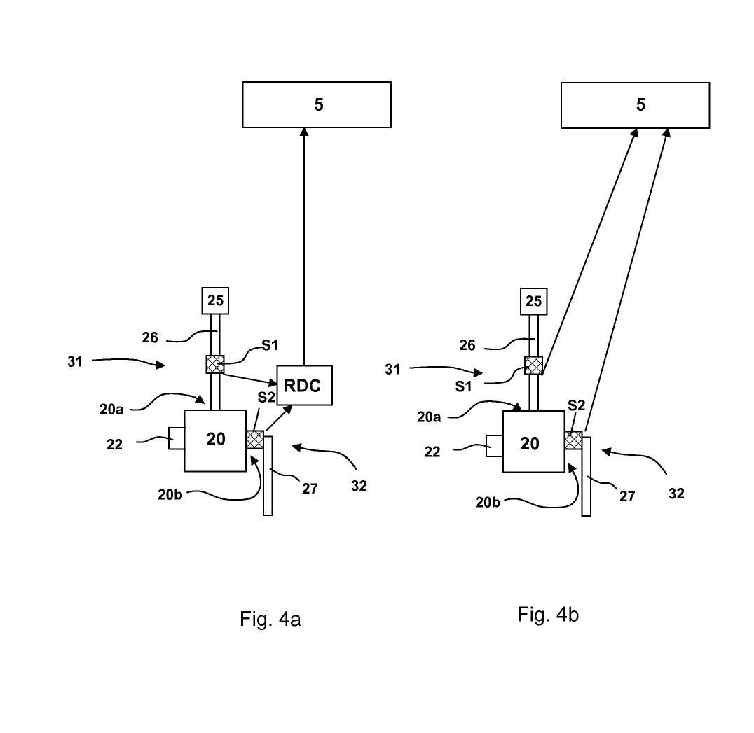

FIG. 4a is an embodiment of an adjustment device according to the invention, in which the load sensor arranged on the output side thereof is designed as a force sensor, and in which the two load sensors are functionally linked with a local data concentrator; and

FIG. 4b is an embodiment of an adjustment device according to the invention, in which the load sensor arranged on the output side thereof is designed as a force sensor, and in which the two load sensors are functionally directly linked with a central controller/monitor.

FIG. 1 shows an embodiment of the high-lift system 1 according to the invention for adjusting at least one landing flap on each wing. FIG. 1 depicts two landing flaps, which are allocated to each wing (not shown on FIG. 1). Shown in particular are an inner landing flap A1 and outer landing flap A2 on a first wing, and an inner landing flap B1 and outer landing flap B2 on a second wing. The high-lift system according to the invention can also be provided with one or more than two landing flaps per wing. The high-lift system 1 is actuated and controlled by way of a pilot interface, which in particular has an actuating unit 3, such as an actuating lever. The actuating unit 3 is functionally coupled with a controller/monitor 5, which relays control commands via an actuating line 8 for actuating a central drive unit 7. The controller/monitor 5 is a central controller/monitor 5, i.e., it has control and monitoring functions for several, and in particular all, adjustment devices A11, A12, B11, B12, A21, A22, B21, B22 of the high-lift system.

The central drive unit 7, i.e., the one arranged in the fuselage area, can be provided with one or more drive motors. In the embodiment of the high-lift system shown, the drive unit 7 has two drive motors Ma-, M-b, which can be realized by a hydraulic motor and electric motor, for example. In addition, the drive unit 7 can have at least one braking device allocated to the drive motors M-a, M-b, which can be actuated by a respective command signal from the controller/monitor 5. In the embodiment of the high-lift system shown on FIG. 1, the drive unit 7 has two braking devices B-a, B-b, which each can be actuated by a command signal from the controller/monitor 5. The at least one braking device is functionally linked with the controller/monitor 5, which in response to predetermined conditions actuates the braking device, and can thereby lock the rotating shaft power trains 11, 12. A defect in the drive motor or one of several drive motors can be eliminated by the central drive unit 7 or a drive motor controller allocated to the at least one drive motor.

As shown on FIG. 1, the central drive unit 7 can have a differential coupled with the output sides of the hydraulic motor M-a and electric motor M-b in such a way that the power levels furnished by the respective hydraulic motor H and electric motor are added together and transmitted to rotating drive shafts 11, 12. The exemplary embodiment of the high-lift system according to the invention shown on FIG. 1 is further provided with two braking devices B-a, B-b, which are functionally linked with the controller/monitor 5. The controller/monitor 5 is designed in such a way as to actuate the braking devices B-a, B-b in response to predetermined conditions, allowing it to lock the rotating shaft power trains 11, 12. If one of the two drive motors is turned off, e.g., the hydraulic motor H or electric drive E in the exemplary embodiment shown, the central drive unit 7 puts out a power reduced by the amount correlating with the deactivated drive motor in accordance with the differential, which is based on the respective power levels furnished by the hydraulic motor H and electric motor.

A total of two rotating drive shafts 11, 12 are coupled to the central drive unit 7 for actuating the at least one flap A1, A2 or B1, B2 per wing. The two rotating drive shafts 11, 12 are coupled to the central drive unit 7, which synchronizes them to each other. In response to corresponding control commands, the central drive unit 7 imparts rotation to the rotating drive shafts 11, 12 to execute servo motions of the adjustment devices of the respective flap coupled thereto. A load limiter or torque limiter T can be integrated into a shaft section of the rotating drive shafts 11, 12 located in proximity to the drive unit 7.

At least one adjustment device is coupled to each flap A1, A2 or B1, B2 for purposes of their adjustment. In the high-lift system shown on FIG. 1, a respective two adjustment devices are allocated to each flap, specifically the adjustment devices A11, A12 or B11, B12 on the inner flaps A1 and B1, and the adjustment devices A21, A22 or B21, B22 on the outer flaps A2 and B2. The at least one adjustment device that actuates a respective flap is referred to as an adjustment station below.

Adjustment devices A11, A12, B11, B12, A21, A22, B21, B22 are described below, wherein the components of various adjustment devices that have the identical function in each adjustment device are labeled with the same reference number.

Each of the adjustment devices A11, A12, B11, B12, A21, A22, B21, B22 has an actuator or speed-transforming gear 20, adjustment kinematics VK for kinematically coupling the actuator 20 to the adjustment flap, and an optional position sensor 22, gearing 25 and at least two load-sensors 31, 32. The gearing 25 converts the motion of the respective drive shaft 11, 12 into the motion of a drive section or drive element 24 coupled with the actuator 20, so as to impart an input motion to an input element 20a or a downdrive link on the input side of the actuator 20.

For example, the adjustment kinematics VK can take the form of a track-carriage adjustment device with a carriage (carriage) movable on a guiding path (track), to which the respective flap is coupled, or of a dropped-hinge adjustment device with an adjustment lever that can rotate around a fixed flap fulcrum, to which the respective flap is coupled. The actuator or speed-transforming gear 20 is mechanically coupled to the respective rotating drive shafts 11, 12, and converts a rotating motion of the respective rotating drive shafts 11, 12 into an adjustment motion of the flap area coupled with the respective adjustment devices A11, A12, B11, B12, A21, A22, B21, B22. It can here be provided that each adjustment device A11, A12, B11, B12, A21, A22, B21, B22 of a flap be furnished with a position sensor 22, which determines the current position of the respective flap, and sends this position value to the controller/monitor 5 via a line (not shown).

The output side of the actuator 20 has an output element or output lever 20b, which is coupled with a flap-side coupling device 27 for coupling the actuator 20, and uses a motion introduced on its input side via the input element 20a to impart motion to the flap-side coupling device 27 for adjusting the respective flap A1, A2, B1, B2. The input element 20a and output element 2b are designed as parts with a mechanical function. In particular, the input element 20a or output or transmission element 20b can here be designed as a rotating shaft and/or compression-tension rod. The input element 20a is a torque or force transferring part that introduces mechanical power into the actuator, while the output element 20b conveys the torque generated by the actuator 20 or the force generated by the actuator 20 to the coupling device 27, and hence to the flap. As a result, a mechanical transfer mechanism with a gearing function is present between the input element 20a and output element 20b.

In addition, the ends of the rotating shaft power trains 11 or 12 can exhibit a asymmetry sensor 23, which is also functionally linked with the controller/monitor 5 by a line (not shown), and sends a current value via this line to the controller/monitor 5, which indicates whether the ends of the rotating shaft power trains 11 or 12 are being rotated within a prescribed range, or whether an asymmetrical rotational position of the rotating drive shafts 11 or 12 is present.

Further, each rotating drive shaft 11 or 12 can be provided with a wing tip brake TWB that can block actuation of the respective power train 11 or 12. The one wing tip brake WTB is here arranged in particular at one location of the rotating drive shafts 11 or 12 lying in an outer region of the respective wing. Each wing tip brake WTB is functionally linked with the controller/monitor 5 via a line (also not shown), and can be actuated and operated via this line by the controller/monitor 5. During operation, the normal output state of the wing tip brake WTB is a non-actuated state, in which the latter do not intervene in the rotation of the rotating drive shafts 11 or 12. In response to a corresponding control signal from the controller/monitor 5, the wing tip brakes WTB can be actuated to lock the respectively allocated rotating drive shaft 11 or 12.

In adjustment kinematics VK configured as a dropped-hinge adjustment device, the flap-side coupling device 27 can be formed in particular by a rotatable servo lever, and the actuator by a rotating actuator or rotary actuator. If the adjustment kinematics VK are configured as a track-carriage adjustment device with a carriage (carriage) movable on a guiding path (track), to which the respective flap is coupled, the flap-side coupling device 27 can consist of a combination of a wagon and a lever coupled thereto or a rod, and in this instance in particular a spindle drive. The wagon is here movably mounted on a guiding path (track) secured to the main wing. In both instances, the flap is guided with a flap guide arranged on the main wing, which can be comprised of a lever arrangement or a guiding path.

According to the invention, each adjustment device A11, A12, B11, B12, A21, A22, B21, B22 exhibits a first load sensor S11-a, S12-a, S21-a, S22-a, also generally marked with reference number S1, and a second load sensor S11-b, S12-b, S21-b, S22-b, also generally marked with reference number S2. The first load sensor S11-a, S12-a, S21-a, S22-a and/or the second load sensor S11-b, S12-b, S21-b, S22-b can be a torque sensor or force sensor. The first load sensor S11-a, S12-a, S21-a, S22-a is generally provided on the input side 31 thereof, and can be arranged on the respective drive element 26 and/or on the input element 20a of the respective actuator 20 and/or on a coupling between the drive element 26 and input element 20a. The first load sensor S11-a, S12-a, S21-a, S22-a is designed in such a way as to acquire the load arising in response to the actuation of the central drive unit 7, which is present on the input side of the actuator 20, or transferred to or impressed on the input element of the actuator 20. The second load sensor S11-b, S12-b, S21-b, S22-b can be situated on the output element 20b of the respective actuator 20 and/or on the respective flap-side coupling device 27 and/or on a coupling between the output element 20b and the coupling device 27. The second load sensor S11-b, S12-b, S21-b, S22-b is designed in such a way as to acquire the load arising in response to the actuation of the central drive unit 7, which is present on the output side of the actuator 20, or transferred to the output element of the actuator 20 or impressed on the flap-side coupling device 27.

In this conjunction, load refers generally to a torque and/or force.

The first load-sensor S11-a, S12-a, S21-a, S22-a and the second load sensor S11-b, S12-b, S21-b, S22-b are each functionally linked by a line (not depicted) with an adjustment device evaluating function of an adjustment device monitoring function 40, and relays a current signal value for the amount of the respectively determined load to the adjustment device monitoring function 40 via this line. The adjustment device monitoring function 40 or individual functions thereof can be part of the central controller/monitor 5. As an alternative, the adjustment device monitoring function 40 or individual functions thereof can also be part of a local, and hence decentralized, controller/monitor 41, which is arranged in proximity to the actuator 20 or the actuators 20 allocated to a flap. A decentralized controller/monitor 41 on each adjustment device or on a group of adjustment devices can be provided in particular for a high-lift system that is actuated in a decentralized manner. In this case, the adjustment mechanisms are not actuated by a central drive unit 7, but instead by a respective drive mechanism, which receives commands solely from the central controller/monitor 5, but is not mechanically coupled with drive mechanisms connected to other adjustment flaps. The additional functions of the adjustment device monitoring function 40 can here be implemented in the central controller/monitor 5. Such a decentralized controller/monitor 41 can be secured to the main wing, and be situated in different positions in the wingspan direction. In one exemplary embodiment, the decentralized controller/monitor 41 is arranged viewed in the wingspan direction in a wingspan segment of the main wing into which the flap extends. A respective decentralized controller/monitor 41 for the actuators 20 of a respective flap can here be provided, so that two decentralized controllers/monitors 41 are arranged on each wing in the exemplary embodiment on FIG. 1. As an alternative, each actuator 20, and in particular a carrier section of the respective adjustment device, can accommodate a decentralized controller/monitor 41 in which the adjustment device monitoring function 40 is implemented. A respective decentralized controller/monitor 41 can also be provided for several adjustment devices.

As shown by comparison on FIGS. 4a and 4b, the two load sensors of the adjustment device can be functionally linked with a local data concentrator RDC (FIG. 4a) or functionally linked directly with a central controller/monitor (FIG. 4b). In the exemplary embodiment according to FIG. 4a, the at least one adjustment device connected to a respective adjustment flap can be provided with a respective data concentrator RDC, which is arranged locally in proximity to the respective at least one adjustment device. In particular in this exemplary embodiment, the adjustment device evaluating function and/or adjustment device fault-recognition function can be implemented in the local data concentrator RDC.

The adjustment device monitoring function 40 has an adjustment device evaluating function and an adjustment device fault-recognition function. The adjustment device evaluating function receives the signals of the load sensors and evaluates them, i.e., it derives the corresponding load values from the sensor signals. The adjustment device fault-recognition function can be part of the decentralized controller/monitor 41 or the central controller/monitor 5.

In order to reconfigure the high-lift system when a fault status has been assigned to an adjustment device, the adjustment device fault-recognition function can have allocated to it a high-lift system reconfiguration function, which can also be integrated into the decentralized controller/monitor 41 or central controller/monitor 5. In response to the assignment of at least one fault state to one or more adjustment devices, such a high-lift system reconfiguration function generates reconfiguration commands to one or more adjustment devices as needed to compensate for the respective fault corresponding to the at least one fault state.

Such reconfiguration commands can involve the deactivation of an adjustment device. A reconfiguration command can also involve no longer actuating an adjustment device. This type of reconfiguration command can be sent to 5, so that the latter takes into account such a non-actuation command during the actuation of adjustment devices. The high-lift system can here be designed in such a way, e.g., through redundant components of the adjustment devices, as to tolerate certain faults, and not send commands to adjustment devices should any faults arise. When forming such commands, the high-lift system reconfiguration function takes into account the fault state of all adjustment devices. In another exemplary embodiment of the high-lift system, the decentralized controller/monitor 41 can be designed in such a way as to itself generate even the kind of command for deactivating the respectively allocated adjustment device; however, the centralized controller/monitor 5 integrates a centralized high-lift system reconfiguration function that considers the ramifications for other adjustment devices, whereupon it generates additional reconfiguration commands for other adjustment devices.

According to the invention, the first load sensor S11-a, S12-a, S21-a, S22-a and second load sensor S11-b, S12-b, S21-b, S22-b are functionally linked with an adjustment device fault-recognition function to receive the sensor values ascertained by the load sensors, so as to assign a fault state to the adjustment device. In particular, it can here be provided that the sensor values of the first and second load sensor each be compared with at least one limiting value in the adjustment device fault-recognition function, and that signal values of the first and second load sensor that exceed or dip below this limit be used for determining the fault state of the adjustment device.

To this end, the adjustment device fault-recognition function can use and/or store the transfer function of the actuator 20 respectively allocated thereto. These include the efficiency of the actuator and, depending on the model of actuator, its gear ratio.

In particular, the adjustment device fault-recognition function can be set up to identify the following fault cases:

Given a fault case A, a largely no-load state on the input side 31 or output side 32 of the respective actuator 20 can be determined based on a prescribed no-load limit or no-load limit, from which it is assumed that no load, or at least no operating load, is active or present on the input side 31 or output side 32 of the respective actuator 20 in cases where load sensor values under the no-load limit arise. In particular, the no-load limit can measure ⅕ of the maximum operating load of the actuator, or of the load that here arises on the input side 31 or output side 32 of the latter, especially ⅕. In order to verify that a value has dropped below the no-load limit, it can also be provided that the first load sensor S11-a, S12-a, S21-a, S22-a transfer a sensor signal to the adjustment device fault-recognition function, and indicate a load defined as being under ⅕ of the maximum operating load at the location of the first load sensor, and that the second load sensor S11-b, S12-b, S21-b, S22-b indicate a load defined as being under ⅕ of the maximum operating load at the location of the second load sensor.

Given a breakage or mechanical decoupling (disconnect) of a mechanical transfer section of the input side 31, the output side 32 and/or the flap guide, no load is applied to any of the load sensors 31, 32, so that the first load sensor S11-a, S12-a, S22-a and second load sensor S11-b, S12-b, S21-b, S22-b indicate a value lying under the no-load limit. Consequently, this applies in particular to a breakage of the drive element 26, the input element 20a, the output element 20b, and the flap-side coupling device 27, as well as to a decoupling of at least one of these components in the force or torque transfer chain of the respective adjustment device A11, A12, B11, B12, A21, A22, B21, B22.

According to the invention, when the sensor signals of the first load sensor S11-a, S12-a, S21-a, S22-a and second load sensor S11-b, S12-b, S21-b, S22-b that were sent to the adjustment device fault-recognition function are too low, a breakage or “disconnect” fault state of a mechanical transfer section of the input side 31 and/or a transfer section of the output side 32 is assigned to the respective adjustment device A11, A12, B11, B12, A21, A22, B21, B22, thereby signaling that the respective adjustment device A11, A12, B11, B12, A21, A22, B21, B22 is nonfunctional.

As an option, it can be provided that the adjustment device fault-recognition function checks whether operating mode currently occupied by the aircraft is one where this fault is not critical. In particular a query or condition as to whether the aircraft is on the ground or not can be critical for this purpose. Therefore, if the sensor signals are too low, and the aircraft is simultaneously not in a critical state, a measure for reconfiguring the high-lift system takes place, which can also involve inactivating and no longer actuating the respective adjustment devices A11, A12, B11, B12, A21, A22, B21, B22.

The adjustment device fault-recognition function can also involve fault case B, which relates specifically to a jamming of the flap on the output side 32 of an adjustment device A11, A12, B11, B12, A21, A22, B21, B22, meaning on the output element 20b and/or the flap-side coupling device 27 and/or the flap guide, during which the entire drive torque is applied to the affected adjustment station. This fault case generally causes a flap to jam. This type of jamming can lead to an overload, resulting in a breakage of the power train. In this case, the sum total of forces and/or torques generated by those actuators connected to the respective flap by means of one respective adjustment device A11, A12, B11, B12, A21, A22, B21, B22 is present on the output side of the actuators. In order to make a determination of this fact, the invention generally provides for the condition that the second load sensor S2 generate a signal value corresponding to a load L₂ and transfer it to the adjustment device fault-recognition function if it exceeds a prescribed limit corresponding to an operating load at the location of the second load sensor S2. One condition in particular can be that the operating load, and especially the maximum operating load, and especially the maximum permissible operating load provided for the actuator in question is exceeded. The maximum permissible operating load is the upper limit of the range intended for actuator operation, and in particular the range on the output side 32. This means that this range allows forces and/or torques in components of the output side 32. This range of forces and/or torques is permitted in particular on that component of the output side 32 on which the second load sensor S11-b, S12-b, S21-b, S22-b is arranged. The maximum operating load is the maximum permissible force or maximum permissible torque at this location. Therefore, in this fault case B, the second load sensor S11-b, S12-b, S21-b, S22-b transfers a sensor signal to the adjustment device fault-recognition function corresponding to a load that exceeds the maximum operating load or maximum permissible force or the maximum permissible torque or the greatest load actually arising during normal operation, in particular at the location of the second load sensor. These alternative maximum loads are labeled Lₘₐₓ below, so that these conditions can be described with L₂>Lₘₐₓ.

Such a sensor value is the sole indicator for fault case B. However, it can be stipulated as a further condition if a case of jamming is present on the output side 32 of an adjustment device A11, A12, B11, B12, A21, A22, B21, B22 or the respective adjustment flap allocated thereto that the first load sensor S11-a, S12-a, S21-a, S22-a ascertains a load lying in the range

$${L}_{1} = [ \frac{{L}_{2}}{i} \pm {k}_{1} ]$$

In this case,
Variable “i” is the gear ratio that the actuator realizes between the input side 31 and output side 32,
Constant “k1” is a quantity that defines a range around the respectively determined value

$$\frac{{L}_{2}}{i} ,$$

which takes into account the efficiency of the actuator.

In particular, constant k₁ can be 15% of the maximum operating load that is permitted on the input side 31, and especially at the location of the first load sensor S11-a, S12-a, S21-a, S22-a, or actually arises during normal operation.

Therefore, according to the invention, the adjustment device fault-recognition function generally assigns a case of jamming to the output side 32 of an adjustment device A11, A12, B11, B12, A21, A22, B21, B22 or adjustment kinematics VK of the accompanying adjustment flap
If the second load sensor S2 generates a signal value corresponding to a load L2 and transmits it to the adjustment device fault-recognition function if it exceeds a prescribed limit corresponding to an operating load at the location of the second load sensor S2, wherein it is provided in particular that the load L2 exceed a prescribed maximum load, i.e., if L2>Lmax, and
If the load L1 measured by the first load sensor S1 lies in the operating range of the input side 31 of the respective adjustment kinematics VK that corresponds to the load L2 measured by the second load sensor S2, in particular taking into account the gear ratio and efficiency of the actuator 20, or if

$${L}_{1} = [ \frac{{L}_{2}}{i} \pm {k}_{1} ] .$$

When these conditions are satisfied, the adjustment device fault-recognition function assigns a case of jamming to the output side 32 of an adjustment device A11, A12, B11, B12, A21, A22, B21, B22 of the flap, meaning on the output element 20b and/or on the flap-side coupling device 27.

According to the invention, the adjustment device fault-recognition function can, given a fault case C, ascertain the case of jamming by the actuator or part of the respective adjustment device lying between S1 and S2 if the load L₁ measured by the first load sensor S1 exceeds an operating range of the input side (31) of the respective adjustment kinematics (VK) derived nominally from the load (L₂) measured by the second load sensor (S2). In particular, it can be provided that the load L₁ measured by the first load sensor S1 is more than twice the load L₂ measured by the second load sensor S2 taking into account the gear ratio of the actuator 20. In addition, it can be provided in particular that the adjustment device be assigned a case of jamming for actuator 20 if the first load sensor S1 has ascertained a load value L₁ for which the condition

$${L}_{1} > [ \frac{{L}_{2}}{i} + {k}_{2} ]$$

is satisfied. Constant k₂ makes it possible in particular to take into account the efficiency of the actuator 20. In this condition, the expression

$$[ \frac{{L}_{2}}{i} + {k}_{2} ]$$

describes a load value L₁ corresponding to the load value present on the output side 32, taking into account the gear ratio realized by the actuator 20. To distinguish the condition

$${L}_{1} > [ \frac{{L}_{2}}{i} + {k}_{2} ]$$

of fault case C from the condition

$${L}_{1} = [ \frac{{L}_{2}}{i} \pm {k}_{1} ]$$

of fault case B, it can be provided in particular that the constant k₂ be greater than the constant k₁. In particular, it can here be provided that the constant k₂ be greater than the constant k₁, and especially twice the constant k₁. No verification need be performed for the sensor value of S2, since the force of air acts on the output side 32, and there is no clear analytical correlation between the measured value and the measured value for the first load sensor S1.

The adjustment device fault-recognition function can also have a function in which a fault case D involving a deterioration in efficiency and, for example, an increased friction in the actuator 20, and generally a state of limited performance relative to the respective actuator or a transfer section lying between the first load sensor S1 and second load sensor S2, is detected or assigned on the adjustment device. According to the invention, the adjustment device fault-recognition function assigns a state of limited performance to the actuator 20 or a transfer section lying between the first load sensor S1 and second load sensor S2 if it builds a ratio

$$\frac{{L}_{1}}{{L}_{2}}$$

from the load value L₁ respectively measured by the first load sensor S1 and the load value L₂ respectively measured by the second load sensor S2, and determines when this ratio drops below a prescribed limit k₃. The limit k₃ can here be comprised in particular of

$${k}_{3}^{*} \cdot {( \frac{{L}_{2}}{{L}_{1}} )}_{nom} ,$$

wherein

$${k}_{3} = {k}_{3}^{*} \cdot {( \frac{{L}_{2}}{{L}_{1}} )}_{nom} ,$$

and the ratio

$${( \frac{{L}_{2}}{{L}_{1}} )}_{nom}$$

is a nominal load ratio that results given an intact actuator at a nominal or normal efficiency. As a consequence, the condition can be formulated by the expression

$$\frac{{L}_{l}}{{L}_{1}} < {k}_{3}^{*} \cdot {( \frac{{L}_{2}}{{L}_{1}} )}_{nom}$$

or derived from it.

The conditions

$${L}_{2} < {k}_{3} \cdot {( \frac{{L}_{2}}{{L}_{1}} )}_{nom} \cdot {L}_{1}$$

and/or

$${L}_{1} > \frac{1}{{k}_{3}} \cdot {( \frac{{L}_{1}}{{L}_{2}} )}_{nom} \cdot {L}_{2}$$

can also be used as mathematical reformulations of the initially mentioned formula in place of the condition

$$\frac{{L}_{l}}{{L}_{1}} < {k}_{3}^{*} \cdot {( \frac{{L}_{2}}{{L}_{1}} )}_{nom} .$$

In addition, the adjustment device fault-recognition function can have a function with which a mechanical sensor fault, e.g., a so-called sensor disconnect, also referred to in this conjunction as fault case E, can be assigned to the first load sensor S1 if certain conditions specified below have been satisfied. This is the case if the adjustment device fault-recognition function determines that the first load sensor S1 drops below a prescribed no-load signal value, and the second load sensor S2 exceeds a prescribed load signal value, which indicates a load. The no-load signal value can be defined in particular as described in relation to fault case A. The adjustment device fault-recognition function can have a function that determines the load signal value to be exceeded by the second load sensor S2 to satisfy the aforementioned condition as a function of the respective activation of the actuator and/or as a function of the size and/or type of the command signal sent to the actuator for its activation.

In analogous fashion, the adjustment device fault-recognition function can have a function with which a mechanical sensor fault, and in particular a so-called sensor disconnect (fault case F), can be assigned to the second load sensor S2 if certain conditions cited below to be oppositely defined in relation to fault case E are satisfied. In this case, this assignment comes about if the adjustment device fault-recognition function determines that the second load sensor S2 drops below a prescribed no-load signal value, and the first load sensor S1 exceeds a prescribed load signal value that indicates a load. The no-load signal value can be defined in particular as described in relation to fault case A. The adjustment device fault-recognition function can have a function that determines the load signal value to be exceeded by the first load sensor S1 to satisfy the aforementioned condition as a function of the respective activation of the actuator and/or as a function of the size and/or type of the command signal sent to the actuator for its activation.

The high-lift system reconfiguration function can introduce reconfiguration measures to reconfigure the high-lift system into a reliable system configuration as a function of the fault cases identified by the adjustment device fault-recognition system or based on the assignment of fault states to a component or component combination.

In a high-lift system where the actuators of the adjustment devices A11, A12, B11, B12, A21, A22, B21, B22 are sent commands via electrical lines from a central controller/monitor 5, and where two actuators 20 are connected to a servo flap to actuate the latter, it can be provided that the flap is no longer actuated after the respective adjustment device A11, A12, B11, B12, A21, A22, B21, B22 has been assigned a nonfunctional state (fault case A) by the adjustment device fault-recognition function on an adjustment device. In order to avoid controller asymmetries, it can here further be provided that the servo flap arranged symmetrically to the adjustment flap affected by the fault case in relation to the aircraft longitudinal axis is no longer actuated. In addition, it can be provided that a brake furnished in the actuator 20 for this case is activated to lock the adjustment flap in its current adjustment state.

If the actuators are driven via a shared rotating shaft 11, 12, and the respective components of the adjustment kinematics VK are equipped with a failsafe mechanism, the high-lift system reconfiguration function can provide that the adjustment device in question continue to be actuated.

In such a high-lift system where commands are sent to actuators of the adjustment devices A11, A12, B11, B12, A21, A22, B21, B22 via electric lines of a central controller/monitor, the same optional measures described for fault case A can be introduced given the assignment of fault case B. In a high-lift system according to FIG. 1, in which the adjustment devices A11, A12, B11, B12, A21, A22, B21, B22 are mechanically actuated via rotating drive shafts 11, 12, it can be provided given the assignment of fault case B on an adjustment device that the system be locked via the motor brakes M-a, M-b and/or wing tip brake WTB, so as to avoid system-internal force conflicts.

In a high-lift system that is actuated centrally, i.e., via rotating shafts 11, 12, it may be provided that the controller/monitor 5 or high-lift system reconfiguration function [send] an actuation signal to a wing tip brake WTB as well as to the at least one braking device B-a, B-b to lock both shaft trains 11, 12 given an impermissible deviation of the set positions determined by the controller/monitor 5 from the actual positions acquired by the position sensors.

In addition, the high-lift system reconfiguration function can be configured in such a way that the signal value L1_RW determined by the first load sensor S1_RW of the right wing is compared for an applied load with the signal value generated by the first load sensor S1_LW on the adjustment device of the left wing symmetrically arranged relative to the aforementioned adjustment device. The adjustment device fault-recognition function can here assign a case of jamming, for example, to the respective right flap even at low loads, if the loads L1, L2 respectively determined based on the signal values L1_RW, L1_LW deviate from each other by a minimum value. Therefore, the condition

M−A_{—}RH>M−A_{—}KH+k₅

must be satisfied to assign this case of jamming.

The difference can be constantly prescribed or determined as a function of load. A case of jamming can be ascertained for the respective left flap in the opposite way.

1. An adjustment device to be coupled to an adjustment flap of an aircraft, comprising:
an actuator and adjustment kinematics for kinematically coupling the actuator to the adjustment flap,
a first load sensor, which is arranged on the input side of the actuator for determining the load arising on the input side of the actuator due to the actuation of the adjustment flap,
a second load sensor, which is arranged on the output side of the actuator for determining the load arising on the output side of the actuator due to the actuation of the adjustment flap, wherein the first load sensor and second load sensor are functionally linked with an adjustment device fault-recognition function for transferring the sensor values ascertained by the load sensors, so as to monitor the functional state of the adjustment device.

2. The combination of an adjustment device according to claim 1 and an adjustment device fault-recognition function, wherein the first load sensor and second load sensor are functionally linked with an adjustment device fault-recognition function for transferring the sensor values ascertained by the load sensors, wherein the adjustment device fault-recognition function is designed in such a way as to be able to monitor the functional state of the adjustment device.

3. The combination of an adjustment device and an adjustment device fault-recognition function of claim 2, wherein the adjustment device fault-recognition function compares the respective sensor values of the first and second load sensor with at least one limiting value in, and determines the fault state of the adjustment device based on whether the signal values of the first and second load sensor exceed or dip below this limiting value.

4. The combination of an adjustment device and an adjustment device fault-recognition function of claim 2, wherein, in a case where the first load sensor and second load sensor each detect values below a no-load limit, the adjustment device fault recognition function assigns a ‘nonfunctional’ state to the respective adjustment device.

5. The combination of an adjustment device and an adjustment device fault-recognition function of claim 2, wherein a value has dropped below the no-load limit if the first load sensor transmits a sensor signal to the adjustment device fault recognition function measuring less than a no-load limit, the value of which is under ⅕ of the value corresponding to the maximum prescribed or actual operating load at the location of the first load sensor, and the second load sensor transmits a sensor signal to the adjustment device fault recognition function measuring less than a no-load limit, the value of which is under ⅕ of the value corresponding to the maximum prescribed or actual operating load at the location of the first load sensor.

6. The combination of an adjustment device and an adjustment device fault-recognition function of claim 5, wherein the ‘nonfunctional’ state is assigned given compliance with the condition that the aircraft is on the ground at the same time the value dips below the no-load limit.

7. The combination of an adjustment device and an adjustment device fault-recognition function of claim 2, wherein the adjustment device fault recognition function assigns a fault state to the adjustment device if the second load sensor generates and transmits to the adjustment device fault recognition function a signal value corresponding to a load L2, which exceeds a prescribed limiting value corresponding to an operating load at the location of the second load sensor, and if the load L1 measured by the first load sensor lies in the operating range of the input side of the respective adjustment kinematics corresponding to that of the load measured by the second load sensor.

8. The combination of an adjustment device and an adjustment device fault-recognition function of claim 7, wherein the prescribed limiting value for an operating load at the location of the second load sensor is a prescribed maximum load for the output side.

9. The combination of an adjustment device and an adjustment device fault-recognition function of claim 2, wherein the adjustment device fault recognition function assigns a fault state to the respective adjustment device if the signal value for a load of the input side generated by the first load sensor exceeds a value that the adjustment device fault recognition function ascertains from the load measured by the second load sensor.

10. The combination of an adjustment device and an adjustment device fault-recognition function of claim 8, wherein the load L1 measured by the first load sensor more than doubles the load L2 measured by the second load sensor, taking onto account the gear ratio of the actuator.

11. The combination of an adjustment device and an adjustment device fault-recognition function of claim 2, wherein in a case, the adjustment device fault recognition function assigns a fault state to an actuator or transmission section lying between the first load sensor and second load sensor if the adjustment device fault recognition function determines that the load ascertained with the first load sensor exceeds a prescribed limiting value, and the load ascertained with the second load sensor dips below a prescribed limiting value, or if the ratio of the load ascertained with the first load sensor exceeds a prescribed limiting value in relation to the load ascertained with the second load sensor.

12. The combination of an adjustment device and an adjustment device fault-recognition function of claim 2, wherein a position sensor can be arranged on the adjustment kinematics to acquire the position of the adjustment flap.

13. A fault-tolerant adjustment system with at least one flap that can be adjusted on one of the respective wings of an aircraft, comprising:
adjustment devices, at least one of which is arranged on a flap and coupled to a drive connection, wherein each adjustment device has an actuator and adjustment kinematics for kinematically coupling the actuator to the adjustment flap, and wherein at least one of the adjustment devices of the flap has: a first load sensor on the input side of the actuator for acquiring a load and a second load sensor on the output side of the actuator for a acquiring a load,
a controller/monitor functionally linked with the load sensors, which is to be able to assign a fault state to the servo devices allocated to a flap based on the signals transmitted by the load sensors.

14. The fault-tolerant adjustment system of claim 13, wherein the fault-tolerant adjustment system comprises several drive mechanisms, one of which is respectively allocated to at least one adjustment device of a respective flap, which are functionally linked with a controller/monitor that actuates the latter, and each includes: two drive motors, two braking devices, wherein the drive motors have allocated to them at least one braking device for stopping the output of the respective drive motor;
wherein the adjustment devices are coupled to a drive mechanism respectively allocated to the flap by means of a respective drive connection, and
wherein at least two adjustment devices are connected to each flap, and spaced apart in the wingspan direction of the flap.

15. The fault-tolerant adjustment system of claim 13, wherein the drive mechanism coupled with at least one adjustment device comprises at least one braking device, and that the controller/monitor comprises:
a servo function for actuating the drive mechanism of the flap,
a monitoring function that generates a command signal to at least one braking device for its actuation, and sends it to the latter if the monitoring function of the adjustment device has assigned a fault state.

16. The fault-tolerant adjustment system of claim 13, wherein the drive mechanism coupled with at least one adjustment device comprises at least one braking device, and that the controller/monitor comprises:
a servo function for actuating the drive mechanism of the flap,
a monitoring function that generates a command signal to at least one braking device for its actuation, and sends it to the latter if the monitoring function of the adjustment device has ascertained varying adjustment states that exceed a predetermined level based on a comparison of sensor values of position sensors on two different adjustment devices of a flap.

17. The fault-tolerant adjustment system of claim 13, wherein the fault-tolerant adjustment system comprises a drive unit, which is actuated by the controller/monitor, and mechanically coupled by means of a rotating shaft with the adjustment devices of both wings for purposes of their actuation.

18. The fault-tolerant adjustment system of claim 13, wherein the fault-tolerant adjustment system comprises a high-lift system reconfiguration function, which is functionally linked with an adjustment device fault recognition function, and generates or influences commands for actuating the adjustment devices as a function of fault states transmitted to it by the adjustment device fault recognition function.

19. A method for reconfiguring an adjustment system with adjustable adjustment flaps, the method comprising:
determining signal values from a first load sensor and a second load sensor to determine loads arising on an adjustment device with an actuator, wherein the first load sensor is arranged on the input side, and the second load sensor is arranged on the output side,
subject to a determination of whether the conditions relating to the signal values ascertained by the first load sensor and second load sensor have been met, assigning a fault state on a component of the respective adjustment device.
